(19) United States
(12) Patent Application Publication
(10) Pub. No.: US 2013/0278427 A1
(43) Pub. Date: Oct. 24, 2013

(54) Method and system for visually reporting a local environmental condition

(71) Applicant: Michael Setton, Crolles (FR)

(72) Inventor: Michael Setton, Crolles (FR)

(21) Appl. No.: 13/545,160

(22) Filed: Jul. 10, 2012

Related U.S. Application Data
(60) Provisional application No. 61/636,691, filed on Apr. 22, 2012.

(51) Int. Cl. G08B 17/10; G08B 17/12; G08B 17/00; G08B 21/00

(52) U.S. Cl. 340/584; 340/540; 340/600; 340/632

(57) ABSTRACT

A method of reporting local environmental conditions in real time is implemented by providing a sensor that takes measurements of an environmental condition; attaching the sensor to a vehicle, a person, an object such as a street lamp or other structure; and displaying visible light to the public at a scale visible from at least 30 feet from the visible light. The visible light is controlled by a microcontroller receiving information from the sensor. The visible light is either variable to depict the measurements, such as in color, frequency of illumination, or is variable in a plurality of lamps lighted in accordance with the magnitude of the measurements or in accordance with a composite index. The sensor is preferably modular so that it can be swapped in and out of a printed circuit board.

### CROSS-REFERENCE TO RELATED APPLICATION

This application claims the benefit of U.S. Provisional Application No. 61/636,691, filed 22 Apr. 2012, which is hereby incorporated by reference herein.

### TECHNICAL FIELD

In the field of electrical communications, a humanly perceptible signaling system on local environmental conditions.

### BACKGROUND ART

Environmental monitoring is a growing concern.

In urban settings, local authorities seek to enhance sustainability, improve air quality and minimize noise levels. To define action plans, baseline levels and distributions need to be determined. Spatial maps are available for noise, but the maps typically consist of values averaged during 8 to 12 hour periods. For air quality studies, satellite measurements provide evolution over time but at resolutions that are typically hundreds of meters square.

Continuous environmental monitoring is useful for systematically monitoring an environment. Such monitoring may involve data acquisition systems programmed to systematically record air quality environmental data and non-weather data for a site. None of the present systems enable in situ information display in a visual way, be it indoors or outdoors, for public viewing along a street or in a neighborhood. In addition, none permits: automated sensor correction with respect to relative humidity, temperature and air flow at the sensor location; use of visible light communication for sensors placed on vehicles; adjustment of sampling frequency based on the concentration of local environmental contaminants or speed of the sensor through the local environment; and expanding the scope of information available to any person to supplement the local information with time dependent information at the same location.

### SUMMARY OF INVENTION

A method of reporting local environmental conditions is implemented by providing a sensor that takes measurements of an environmental condition; attaching the sensor to a vehicle, a person, or a street lamp or other structures; and displaying visible light to a person where the visible light is controlled by a microcontroller receiving information from the sensor. The visible light is preferably variable to depict the measurements where the visible light varies, such as in color, frequency of illumination or in a plurality of lamps lighted in accordance with the magnitude of the measurements, or is preferably reflective of a composite index. The sensor is preferably modular so that it can be swapped in and out of a printed circuit board. The printed circuit board typically has a microcontroller, a physical storage medium, and an input and output transceiver. The measurements are preferably stored on the physical storage medium and may be transmitted to a remote receiver, such as a centralized server or a person's mobile phone. For sensors attached to a vehicle the microcontroller power mode and data sampling frequency is preferably set automatically using a speed measuring electronic component. The sensor is preferably regularly calibrated using data transmitted to the input and output transceiver from a reference station, such as a central server. Typical sensors measure environmental conditions such as the level of a contaminant like ozone, carbon monoxide, nitrous oxide, nitrogen dioxide, sulfur dioxide, carbon dioxide, volatile organic compounds, radiation, noise, and particulates. Preferably, air flow to the sensor is controlled by a direct current fan to provide a constant air flow through a fixed volume. The method may include measuring temperature and relative humidity values in the vicinity of the sensor and then calculating correction factors for the measurements using the measured temperature and humidity values. Alternatively, the method may involve correcting the measurements by compensating for resistivity spread pertaining to manufacturing or aging of the sensors and maintaining an optimal operating temperature of a sensor while in use.

### Technical Problem

Fixed and mobile systems currently available for measuring various environmental parameters are not able to inform individuals through visible light communication about local conditions being experienced at the level of the person on the ground. For instance, a bicycler pedaling down a street would be more inclined to select street A if indicators at a fork in the road to street B were showing higher pollutants or adverse conditions than on street A.

Today's monitoring systems are rarely connected to the Internet in a manner that permits an unlimited number of sensors and also provides that option at low cost. Prior deployments of a network of fixed stations had as an upper end about 9000 sensor stations and these were fairly large and expensive, making widespread deployment physically and financially impractical. Wireless local connectivity is also restricted to a limited number of concurrent users, and therefore new methods and technologies are needed to enable communication independently of the quantity of simultaneous connections within local range.

Monitoring stations that are dispersed in cities would have better spatial resolution than satellite measurements, but current methods and technologies do not permit the sensor measurements to reflect environmental changes at a person's level.

It is known that air quality can locally change rapidly even across a small portion of a street. Fine-grained environmental measurements in the immediate vicinity of a person and taken over short time periods are simply unavailable with current technology and methods.

With microelectronic miniaturization and nano-technologies, sensors are now smaller and also consuming less power. Therefore, there have been several research studies regarding the feasibility of measuring environmental conditions in mobile contexts.

For use on bicycles, built in sensors from mobile phones, measure location using the phone's GPS, noise level using the microphone and road roughness with an accelerometer.

There are some mobile phone manufacturers that incorporate sensors within the phone itself to take advantage of the already present display and battery pack. However this is not particularly practical as there is no possibility of sensing when the phone is in a pocket or a bag.

Applications on the mobile phone also consume significant power: for example the microphone consumes 225 milliwatts (mW) whereas a GPS function consumes 600 mW. Measuring noise along with geolocation on a smartphone on a continuous basis would quickly drain a mobile phone's battery and therefore risks being disabled or rejected by users.

For air quality measurements, the parameters typically being monitored at a city level are ozone, carbon dioxide (CO2), nitric oxide (NO), nitrogen oxides (NOx), particulates, temperature, and humidity. For person or vehicle mounted sensors, that is for those in mobility situations, a sensor measures air pollution containing carbon monoxide (CO) and ozone detectors with a BLUETOOTH module to transmit the information to a cellular phone that acts as a relay towards a server where the data is integrated into a database, but there is no mechanism for local display.

Other systems use metal oxide semiconductor (MOS) sensors. Due to poor reproducibility in the manufacturing process of MOS sensors, the output voltage in ambient air can be significantly different from one sensor to the next and more importantly their voltage output varies strongly with temperature and relative humidity. A system with stable output voltage or the ability to calibrate variations is necessary, especially one that can provide correct readings when subjected to variations in temperature and relative humidity. Furthermore, prior art focuses on air quality, whereas it is also beneficial to include noise measurements for urban measurements. It is, therefore, necessary to devise new systems and methods that provide calibration means and better sensor sensitivity.

Microcontroller control boards that integrate gas sensors and a particle counter typically connect with a base station (via the Zigbee protocol) and are not capable of directly communicating with mobile phones. These boards also lack a geopositioning device in order to spatially map the air quality.

Other platforms are unable to include embedded temperature and humidity measurements and are not modular to enable inclusion of other sensors such as a microphone to measure ambient noise. Integrating a telephony module within the sensor also means that its power consumption is high.

Therefore current technology and methods employing wireless sensors have weak points, namely: no modularity with a limited set of functions needed for detailed environmental characterization; limited reprogramming for calibration with respect to other environmental parameters such as humidity and temperature once the sensor is deployed; no ability to control air flow; no capability of pulsed mode sensor powering.

### Solution to Problem

Vehicles, people or urban infrastructure are equipped with light emitting diodes (LEDs) in order to visibly display local environmental conditions and provide a system and method for obtaining fine-grained, time dependent environmental information at and around a person's location.

The solution described herein also enables mounting, powering and operating electronic devices in order to collect, transmit, integrate and display spatially and time varying information from a heterogeneous network of mobile and fixed sensors.

On urban furniture, LEDs can be installed on bus stops or street lights, or be integrated into translucent concrete structures. The active sensing device can be hidden from view and do not need to have any means of communication to provide feedback to citizens. One can imagine a pedestrian following the least polluted route without having any Internet-connected device but by following visual guidance.

For visual indicators, LEDs can also be mounted on one or more drones or unmanned aerial vehicles (UAV). As drones fly around, the LED colors change according to the environmental condition being sampled. Such a system enables visual communication even when the drone is out of typical range for radio frequency communication. It could also simplify three-dimensional data representation if simultaneous video recordings were made and then replayed.

Using server processing, data from the UAVs can also guide them to follow a concentration gradient and this way map out and find the source of pollution plumes.

Drones can also be used to recharge sensor batteries using inductive coupling or magnetic resonance. This method is useful in case solar power cannot be used to provide autonomous powering of the sensors.

A system comprising of a combination of sensors for detecting a variety of environmental conditions and situations comprising the deployment of a plurality of mobile sensor devices and fixed stations within a region of interest, wherein each fixed station and a number of mobile sensors are connected to a central server over a communication network, each mobile sensor being capable of detecting at least one of a plurality of conditions such as noise level, air quality, temperature, relative humidity, weather conditions, radiation levels and the like. The system contains at least one central knowledge server that receives sensor data developed by said plurality of sensor devices in a periodic transmission from the sensor devices over a communication network. It enables measurements and processing of geolocation information from a positioning device along with spatially and time dependent parameters.

The sampling frequency of said sensors can be set to be a direct function of the carrier's speed. For air quality related measurements, constant air flow is provided by miniature fans or blowers and constant sensor temperature may be additionally controlled using techniques such as digital potentiometers or thermoelectric heating/cooling. For ease of use, sensor batteries or super capacitors can be recharged using suitable energy scavenging or inductive charging methods, in addition to conventional means.

Operating gas sensors in pulsed current mode saves on energy consumption and improves sensitivity. Within the mobile sensors, relative humidity and temperature measurements provide information enabling improved gas sensing accuracy and measurement reliability using a variety of techniques including neural networks. For Metal Oxide Semiconductor sensors, the effect of oxide layer resistivity dispersion inherent to manufacturing is minimized using programmable resistors or digital potentiometers.

Mobile sensors can be operated in several modes: local display, recording on a storage medium or transmission to an Internet connected relay. Using wired, wireless or visible light communication, the sensors communicate with each other, with mobile phones, with fixed stations which may contain more sensitive and stable measuring devices, or with a database resident on a distant server. Sensors can be automatically recalibrated in situ via calibration information provided by fixed stations.

### Advantageous Effects of Invention

The advantages of visible light communication are: low cost; unlimited number of simultaneous connections; possibility of transmitting advertising messages interspersed with environmental information; and capacity to add augmented reality layers.

### BRIEF DESCRIPTION OF DRAWINGS

The drawings illustrate preferred embodiments of the method of the invention and the reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a chart of the method steps involved in the process.

FIG. 2 is chart of optional method steps in the process.

FIG. 3 illustrates the hardware modules of an embodiment of the device enabling the process steps.

FIG. 4 illustrates a preferred communication setup for the process.

FIG. 5 plots the relationship between a sensor's resistivity as a function of gas concentration at 50% Relative Humidity and 25° C.

FIG. 6 plots the relationship between the log of a sensor's resistivity as a function of relative humidity for a given gas concentration.

FIG. 7 plots the relationship between the log of a sensor's resistivity as a function of temperature.

FIG. 8 plots the relationship between the log of a sensor's resistivity as a function of gas concentration.

FIG. 9 illustrates a fuzzy logic composite index for determining light variability for an environmental variable.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention. For example, the steps in the method of the invention may be performed in any order.

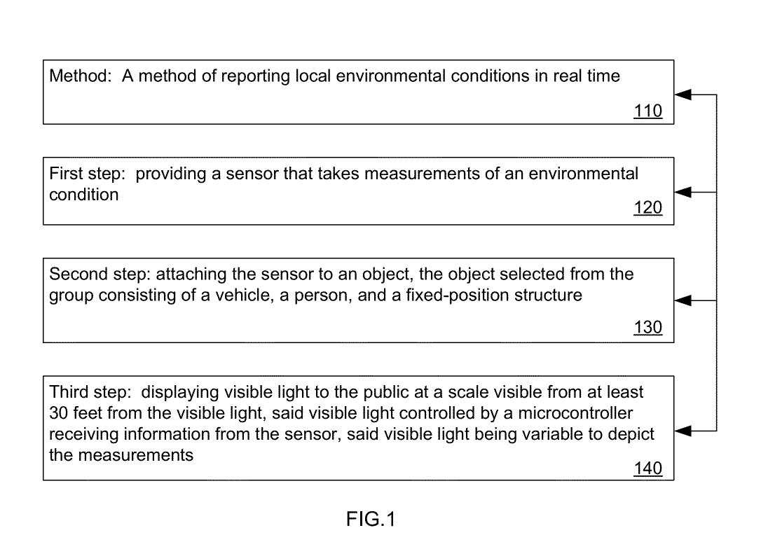

FIG. 1 is a chart of the method steps involved in the process or method (110) of reporting local environmental conditions to the general population. A local environmental condition may involve any type of physical condition of the local environment and reporting is made essentially to people in the vicinity of a sensor.

There are four steps in the preferred embodiment: A First step (120) includes providing a sensor that takes measurements of an environmental condition.

A Second step (130) includes attaching the sensor to an object, the object selected from the group consisting of a vehicle, a person, an object, such as a decorative item, and a fixed-position structure.

A Third step (140) includes displaying visible light to the public at a scale visible from at least 30 feet from the visible light. The concept is to alert people in the public sector the environmental measurements. The visible light is controlled by a microcontroller receiving either local or distant information from the sensor. The visible light is variable to depict the measurements. For example, depiction of the measurements may include light variability or a display drawn from a composite index. Light variability may, for example, be provided by enabling a change in color, flickering frequency or light intensity corresponding to a change in measurement value, or by the number of lamps, such as light emitting diodes, LEDs, lighted. A composite index is preferably computed in several ways based on measured values.

A first method includes a step of taking into account the worst value from a set of specific indices related to the active sensing elements in the system.

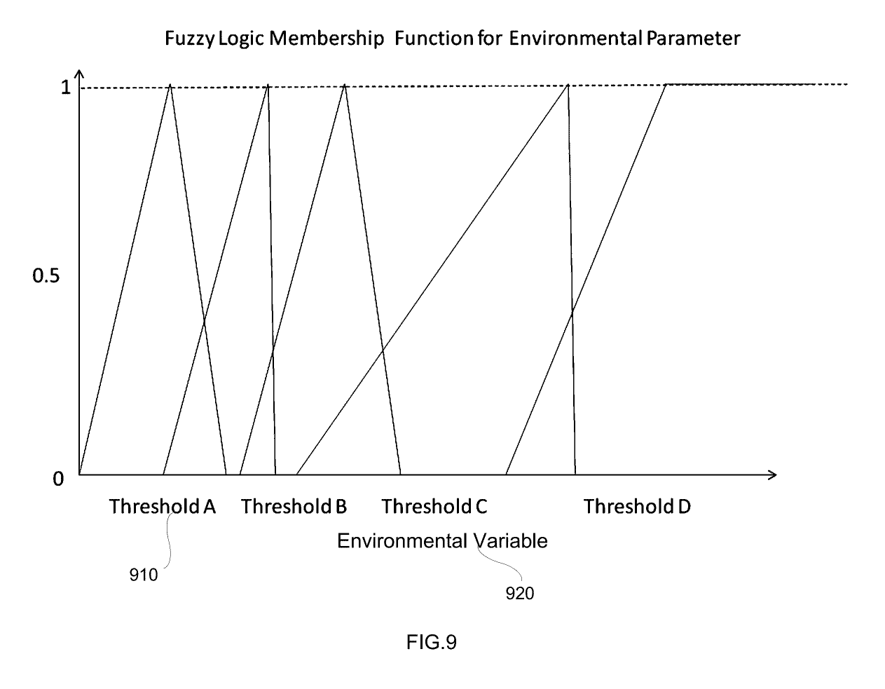

A second method, which is illustrated in FIG. 9 is the most preferred method. FIG. 9 illustrates a fuzzy logic composite index for determining light variability for an environmental variable. This method includes a step of using fuzzy logic. For each environmental parameter measured, the method involves translating numerical input values into descriptive words (e.g. excellent, very good, good, favorable, bad and very bad). The method next involves setting measurement thresholds for each of the descriptive words, such as Threshold A (910), which is represented by the triangle extending from zero at the abscissa to 1 on the ordinate or vertical axis and back down to the abscissa. As can be seen in FIG. 9, the thresholds may overlap, so the logic is described as fuzzy. The thresholds shown may be considered to be membership functions, which in this case is defined by the area within a triangular area, but may be other shapes such as trapezoidal. They show the extent to which a descriptive word value from a domain are defined for each environmental variable (920). The method includes creating a set of rules that define the thresholds, which in turn determine the light output. This method is well suited to situations when the objectives or constraints are not precisely defined, and necessary information is missing, sporadic or discontinuous.

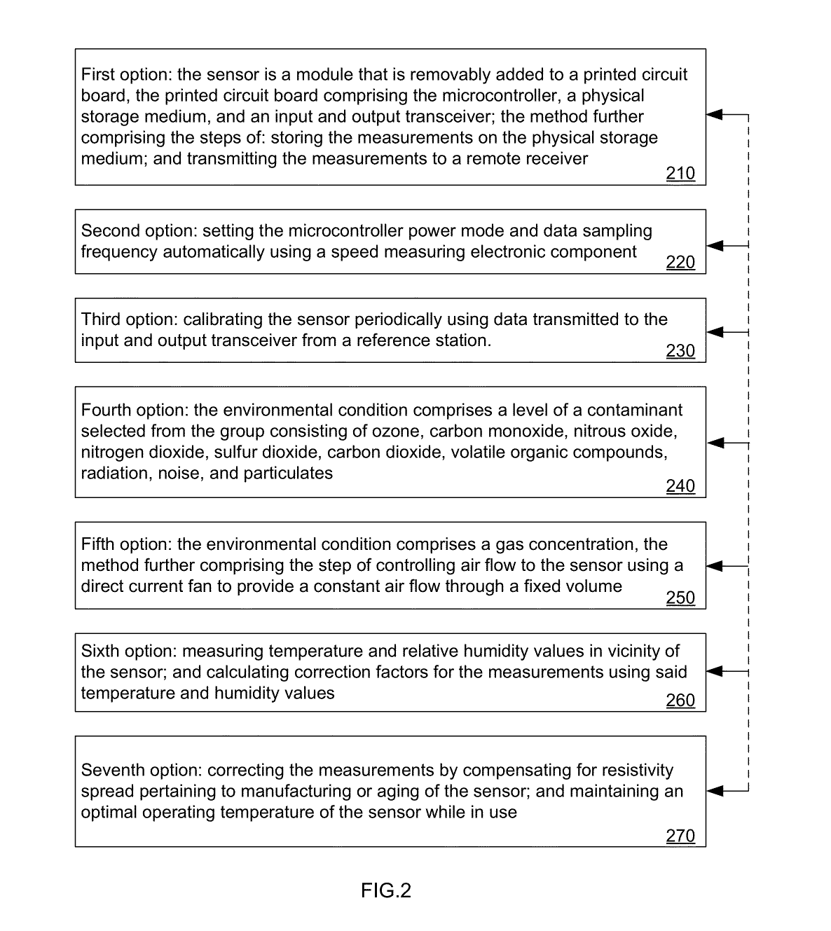

FIG. 2 is a chart of seven options that may be used to supplement the preferred method described in FIG. 1: A First option (210) involves an embodiment where the sensor is a module that is removably added to a printed circuit board. The printed circuit board includes a microcontroller, a physical storage medium, and an input and output transceiver. The method then includes further steps of: storing the measurements on the physical storage medium; and transmitting the measurements to a remote receiver.

A Second option (220) includes the step of setting the microcontroller power mode and data sampling frequency automatically using a speed measuring electronic component.

A Third option (230) includes the step of calibrating the sensor periodically using data transmitted to the input and output transceiver from a reference station.

A Fourth option (240) involves an embodiment where the environmental condition being measured includes a level of a contaminant selected from the group consisting of ozone, carbon monoxide, nitrous oxide, nitrogen dioxide, sulfur dioxide, carbon dioxide, volatile organic compounds, radiation, noise, and particulates.

A Fifth option (250) involves an embodiment where the environmental condition being measured includes a gas concentration. The method then includes the step of controlling air flow to the sensor using a direct current fan to provide a constant air flow through a fixed volume.

A Sixth option (260) includes the steps of: measuring temperature and relative humidity values in vicinity of the sensor and calculating correction factors for the measurements using said temperature and humidity values.

A Seventh option (270) includes the steps of: correcting the measurements by compensating for resistivity spread pertaining to manufacturing or aging of the sensor and maintaining an optimal operating temperature of the sensor while in use.

The sensor is preferably included in a device that is an integrated, modular, reprogrammable device with wired or wireless communication capable of recording, relaying environmental parameters and being periodically calibrated in-situ.

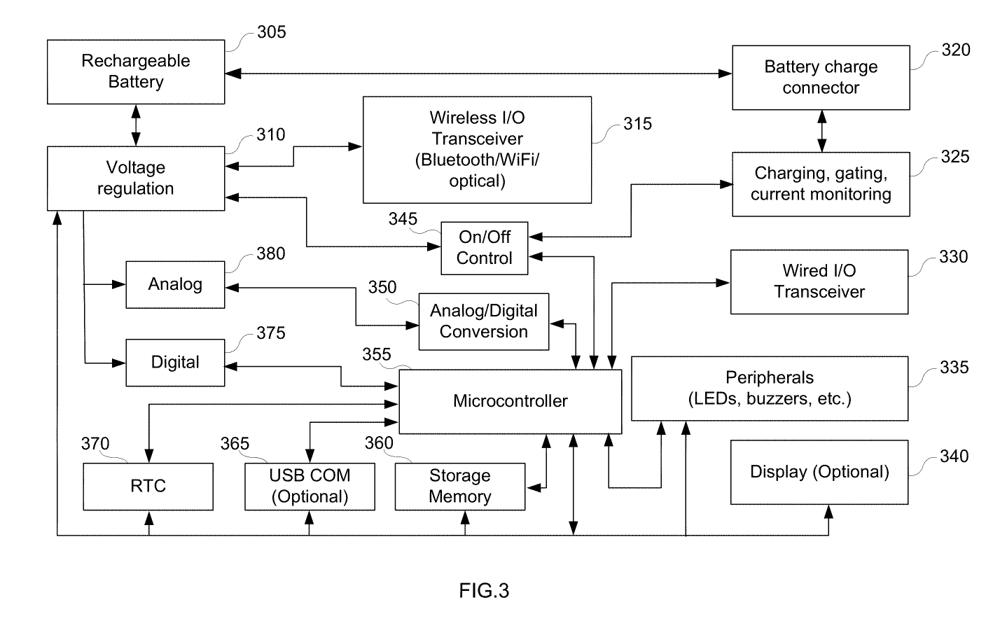

FIG. 3 schematically illustrates the main hardware modules which comprise the device and the main integral functions provided by the device. These modules are contained within a housing which is provided with the means for rendering it wearable by carriers such as pedestrians, bicyclists, motorized vehicles. An on/off control (345) powers the unit up or turns it off.

When a mobile device (a wearable wireless device) is used, a rechargeable battery (305) provides power to operate the device. Battery charge connector (320) is preferably used as a connector for recharging the rechargeable battery (305). Circuitry controls charging, gating, current monitoring (325). As an aid to communication, a wearable wireless device is preferably programmable so that it can comply with industry-standard protocols when transmitting outbound. Wireless I/O Transceiver (315) preferably supports BLUETOOTH, WiFi, or optical transmission protocols. A BLUETOOTH radio (standard or BLUETOOTH Low Energy) may be used, although other technologies such as ETHERNET, ZIGBEE, WIFI DIRECT, WIMAX, or proprietary protocols may also be substituted if desired. A wired device preferably employs a Wired I/O Transceiver (330). Voltage regulation (310) provides consistent power supply to the Analog (380) and Digital (375) sensors. When an analog sensor measurement is made the device employs Analog/Digital Conversion (350) to convert the reading to digital. Digital operations are controlled by a microcontroller (355), which may include operation of Peripherals, such as LEDs, buzzers, etc. (335). The Microcontroller (355) may also include a Real-Time-Clock, RTC (370); optional USB COM ports; storage memory (360), which is a physical component, such as Random Access Memory, or solid state memory; and a Display (340).

If a BLUETOOTH (IEEE 802.15.4) or WIFI (IEEE 802.11) radio-frequency, RF, radio is used, this has the added benefit of allowing communication with relay devices such as mobile phones, personal digital assistants (PDAs), personal computers (PCs) or any relay to another network such as cellular or internet. On a SMARTPHONE, BLUETOOTH communication typically requires less than 90 mW.

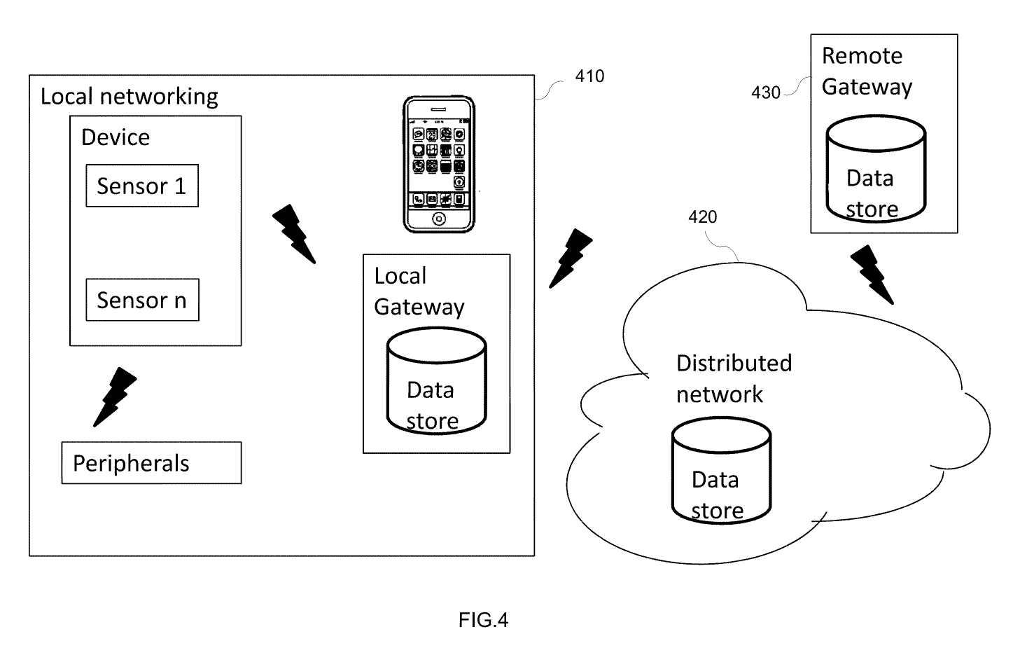

A preferred communication setup is shown in FIG. 4. In Data Box 410, data is collected and displayed either on a local device or accessing a web page if the data has been sent to a distant server. Gateways for transmission to a server and data storage through a Remote Gateway (430) may include mobile phones, plug computers or any device with Internet connectivity. It is also preferable to include a full telephony module (such as General Packet Radio Services (GPRS), High-Speed Code Division Multiple Access (HS CDMA), Universal Mobile Telecommunications System (UMTS), etc.) within the device so that it can be used without a separate mobile phone.

Connectivity to Local Area Networks (LAN) may be enabled by, for example, embedded internet connectivity using integrated circuits, such as Microchip ENC424J600, ENC28J60 or Asix AX88796C encoders/Controllers. Other modules or devices may provide equivalent functionality to lower costs and energy consumption, while sending data using standard TCP/IP packets. This enables capabilities of a Distributed Network (420) for storing and using measurement data.

Data transmission can occur either on a continuous mode or as data bursts depending on the type of data being transmitted and according to the power management requirements of the particular application. As well, the data sampling rate can be adjusted via a simple software parameter.

A communication mechanism may be visible light communication. Such method has been shown to be viable using mobile phones and urban infrastructure such as street lights or traffic light fixtures.

To stream the data in real time from mobile phones, a software application is loaded and running to transfer data using the User Datagram Protocol (UDP) protocol. Other protocols, such as Hypertext Transfer Protocol (HTTP), or Message Queue Telemetry Transport (MQTT), may also be used. The data from the various sensors is parsed and written to corresponding tables of a Structured Query Language (SQL) database. Global Positioning System (GPS) data consisting of date, time, longitude, latitude as a minimum is streamed, preferably with a National Marine Electronics Association (NMEA) protocol.

To retrieve data for access via a web browser, a query is sent to the database and web services are invoked.

In order to run the device in a low power mode, it is also possible to record the data on a storage medium (such as a memory card) incorporated in the sensor and periodically transfer the information contained on such memory to an Internet connected station.

Sensors: The device has been designed and engineered to be capable of interfacing with a variety of analog and digital sensors using a serial interface and connected to the microcontroller via serial communication Universal Asynchronous Receiver/Transmitter (UART), Inter-Integrated Circuit (I2C), or Serial Peripheral Interface (SPI): for example,
D GPS: The GPS present in the various units provides spatio temporal correlation;
D CO, ozone, CO2 sensor, NOx, particles;
D Microphone for ambient noise level;
D temperature and humidity;
D UV (A, B), alpha, beta or gamma radiation levels;
D etc.

Other parameters are measurable without departing from the scope of the present invention. For example, since there is a strong correlation between NOx levels and fine particles, a separate unit for particle measurement can be added to the infrastructure (such as made by SHINYEI PPD 42NS, PPD60 PV or SHARP DUST SENSOR GP2Y1010AU0F).

For gas sensing, it is preferable to use Metal Oxide Semiconductor (MOS) systems: MICS 2610 or MICS 2611 sensors for ozone, MICS 4514 for and NOx, MICS 5135 For VOCs and ELTi M550 or S100H for CO2.

Other brands of MOS sensors from companies like FIS or FIGARO (e.g.; FIGARO 4161 for CO2), Applied Sensor. Electrochemical sensors may also be used for example from the CITYCELL or ALPHASENSE brands.

For temperature and humidity measurements, SENSIRION SHT11 or SHT21 modules are incorporated in the system.

To increase air flow and provide a steady amount of air to the sensing units, the system may incorporate miniature fans.

A preferred geopositioning device is a LOCOSYS LS20036, and the BLUETOOTH radio a BLUEGIGA WT12 module. Equivalent components may be used without departing from the scope of this invention.

For radiation level monitoring, several techniques can be used: the sensing element can be a Geiger tube (e.g. LND 712) or a reverse biased PIN Photodiode.

Transducer response: For Metal Oxide Semiconductor sensors, the changes in composition of the ambient atmosphere determine changes in the resistance of the sensing layers. In practice, the relationship between sensor resistance and concentration of the target gas usually follows a power law that can be described by: R=k×cⁿ (1), where: c=concentration of target gas; k=a measurement constant n has values between 0.3 and 0.8; a positive sign is used for oxidizing gases, while a negative sign is used for reducing gases.

A simple resistor bridge is used to measure sensor resistance, Rs. The heating voltage, VH, has typical values ranging between 2 and 5 volts (V). To determine Rs, the output voltage, Vout, is measured and RL (R Load) is known from the resistor value on the Printed circuit board. The relationship between Rs and Vout can be described by:

$${V}_{gas}^{out} = \frac{Supply voltage \times {R}_{load gas}}{Rs + {R}_{load gas}} \qquad ( Equation 1 )$$

With Metal Oxide Semiconductor sensors, since temperature and humidity strongly influence the gas concentration measurements, incorporation of sensors providing both values of relative humidity and gas sensing active element's temperature is critical in order to obtain reliable values of gaseous species.

As described in “Characterization of humidity dependence of a metal oxide semiconductor sensor array using partial least squares,” by Jae Ho Sohn, Michael Atzeni, Les Zeller, and Giovanni Pioggia, Sensors and Actuators B 131 (2008) 230-235, the relationship between the sensor's resistance Rs and relative humidity Rh (in %), follows an exponential decay model equation: Rs=c+a exp(−b×Rh); where a, b and c are constants specific to each type of gas being sensed.

Therefore, Equation 1 above should be corrected appropriately, depending on the relative humidity value. To perform such correction, a table of coefficients a, b and c are preferably stored in the microcontroller, or are calculated via software on a server or on a computing device in order to automatically compensate for such dependency and reduce the measurement error. Artificial neural networks can also be “trained” in order to obtain accurate measurements independently of humidity and temperature, as detailed in publications (A Smart Gas Sensor Insensitive to Humidity and Temperature Variations, by Mohammadreza Hajmirzaheydaral and Vahid Ghafarinia, 2011 IOP Conf. Ser.: Mater. Sci. Eng. 17 012047 and also A Novel Neural Network-Based Technique for Smart Gas Sensors Operating in a Dynamic Environment, H. Baha, Z. Dibi, Sensors 2009, 9, 8944-8960).

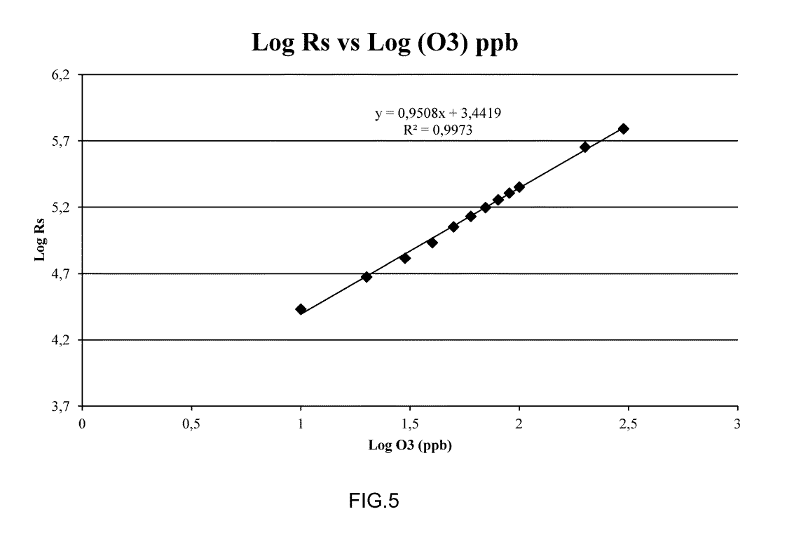

FIG. 5 exemplifies a curve indicating sensor resistivity, Rs, as a function of gas concentration at 50% Relative Humidity, RH, and 25° C. These are available from most sensor manufacturers. The methodology to obtain meaningful results (and assuming that there is little correlation between temperature and humidity dependence) involves sensor initial characterization, including humidity characterization and temperature characterization.

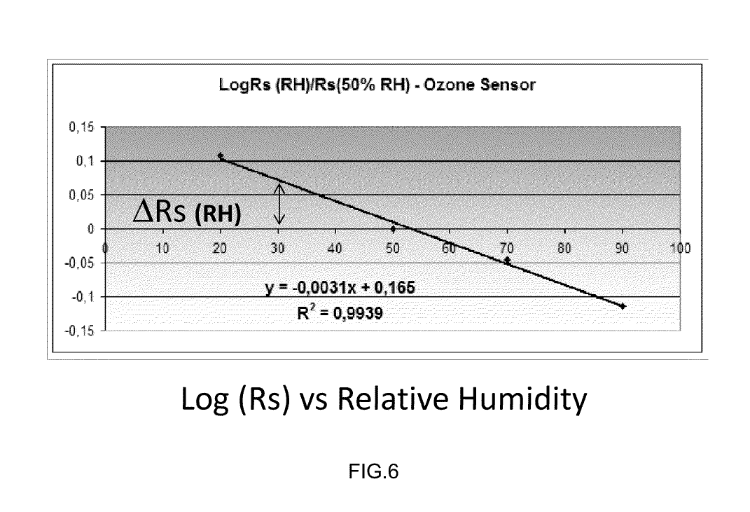

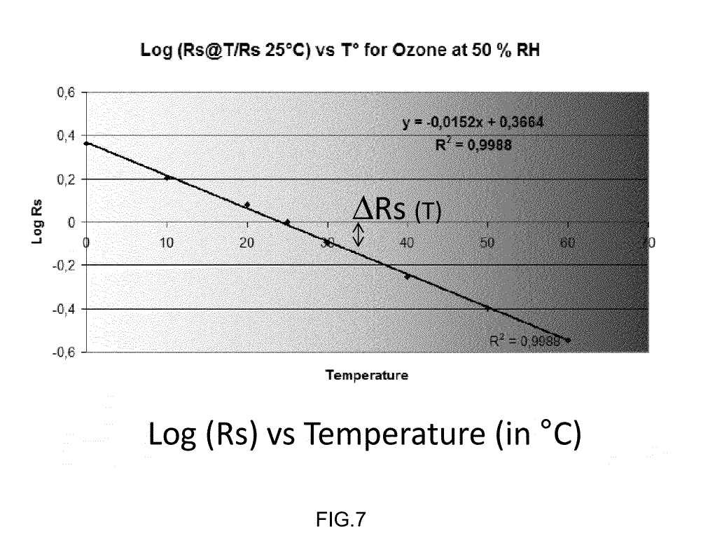

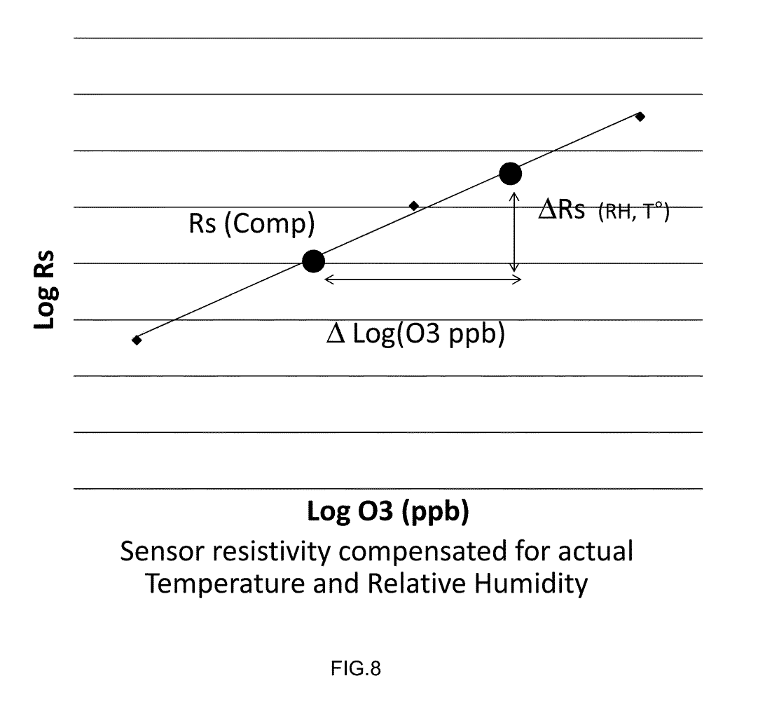

For humidity characterization, FIG. 6 exemplifies a plot a given gas concentration, plot Log (Rs) versus, vs, RH. For temperature characterization, FIG. 7 exemplifies a plot using a given gas concentration, plot Log (Rs) vs Temperature. In routine sensor use, whenever a measurement is made along with environmental parameters relative humidity and temperature as measured in the immediate vicinity of the sensing element, a 2D projection is preferably performed in 3 steps: Step 1: Calculate what the sensor resistivity would be at 50% RH. Relative humidity. Step 2: Compute what resistivity shift is due to temperature difference with respect to 25° C. One obtains a new “Compensated Rs” (Labeled R Comp) equivalent to what the resistivity would be in 50% RH, 25° C. conditions. Step 3: Refer to the Log (Rs) vs Log (Gas concentration) to obtain actual gas concentration corresponding to R Comp, which is illustrated in FIG. 8.

Another issue with sensors using semiconductor oxide sensing layers, such as tin oxide, SnO2, is that the resistivity of the layer can vary greatly within one batch. As explained by manufacturer e2V: “On the baseline resistance, a factor of 5 in production spread is typical. The sensitivity is typically spread over a factor of 2 to 8 depending on the target gas.”

Therefore, it is preferable to replace the typically fixed-load resistance RI in circuit provided in figure with a variable potentiometer or programmable resistor. The methodology is the following: the concentration of a gas species in the ambient atmosphere is determined by a reference instrument; and relative humidity and temperature are measured as well. For a batch of devices, the sensor output voltage Vs is measured for each device and the load resistance is adjusted in order to minimize dispersion in the output voltages.

Typically, in cities, there are a few fixed reference stations containing highly sensitive laboratory grade instruments. For each gas specie of interest, initial calibration tables are obtained by placing the sensors next to reference instruments and minimizing the sum of squared differences between sensor readings and said reference stations.

For CO2, Metal Oxide Semiconductor (MOS) sensors may also be used, but in the preferred embodiment, it is preferable to integrate a non-dispersive infrared technology. This technology has the advantage of being less influenced by temperature and humidity than MOS sensors.

To measure sound pressure (i.e. noise level) over a wide range, the amplification circuit contains several stages of amplification. Depending on the noise level input, four gains are automatically selected, respectively ˜2000, ˜400, ˜100 and 20 (from low noise levels to high noise levels).

A nearly linear relationship is therefore obtained. An “A-weighting” filter is preferably added to the printed circuit board (PCB) to account for the fact that human hearing is less sensitive at low and high frequencies than in the upper midrange, and that this variation is dependent upon the sound intensity. This way, sound levels are preferably provided in decibel A (dBA), a more common standard with regard to noise control issues, regulations and environmental standards.

Power: Preferably, the microcontroller manages a 3.7 V lithium ion battery. This battery can be recharged from a standard USB port of a computer, a USB wall adapter or from a power supply plugged in a wall socket with adequate transformer to output 5V, or a human powered generator (bicycle hub or bottle dynamo with USB output). Examples of such a device is the PEDAL POWER+OR BIO RECHARGE which recharges a built-in battery which then output power to a USB port. However, preferred embodiments do not require a bicycle dynamo to be connected to at least one bicycle lamp.

In other embodiments, the battery is recharged from a solar cell. Continuous progress in these cells' conversion efficiency assures that the required “real estate” required to produce a given power output and intensity will continue to be reduced. If a solar cell is used, a capacitor can serve as a buffer to store energy temporarily. To recharge the battery, inductive charging can also be advantageously used.

Since lithium polymer batteries cannot be recharged below zero degrees Centigrade (0° C.), in cases of exposure to cold weather, the temperature probe located inside the casing can be used to safeguard the battery. If necessary, lithium polymer cells can be substituted by chloride thionyl batteries or super capacitors.

Geolocation and Time Synchronization: Preferably, data transmission takes place on a continuous basis. Alternatively, to reduce the volume of data to be transferred, transmission is initiated only when certain threshold values are reached. When the geopositioning device cannot obtain an accurate position in the absence of a signal (for example inside structures), data is recorded on the storage medium for later transmission. Since the geolocation device obtains accurate time from the satellite constellation, time can be used to regularly reset a real time clock.

Local data storage: In order to preserve the data even when the communication link is interrupted, or to save on costs, data coming from the various sensors can be simply recorded or simultaneously transmitted via the wireless radio and written to local storage. This recording medium can consist of any solid state memory such as EEPROMs or removable media. Preferably, local data storages is by a TRANSFLASH 2G SD (also known as MICROSD) memory card. The data format of files written onto the memory may be FAT16, FAT32 or other format. With such a configuration, the device could be used in both connected and disconnected settings.

Microcontroller: A preferred microcontroller is TEXAS INSTRUMENT MSP430 microcontroller because of its ultra-low power consumption, built-in memory and ease of programming. The MSP430 is a 16-bit RISC based processor capable of handling both analog and digital peripherals and it possesses both UART and SPI interfaces. For advanced applications, it can interface with a Digital Signal Processing (DSP) circuit, in which case the microcontroller manages the DSP and places it in power saving mode whenever possible to save battery drain.

In another embodiment and to deal with applications requiring more processing power (for example if a mobile communication module is substituted for the short range wireless radio), more powerful microcontrollers such as those based on the ARM CORTEX series M3, ARM 7 or ARM 9 architectures may be employed.

Real Time Clock: An onboard real-time clock synchronizes all events and signals in the unit. Unless time information is available from the onboard GPS/UTC chip, this Real Time Clock will be used as the default “time-keeper.” The time and date for this clock is set through a configurable menu option at setup time.

Sensing units can also contain a display such as Liquid Crystal Display, LCD or organic light-emitting diode, OLED, display, with or without touch screen or backlighting. Future display technologies such as flexible displays may be substituted. For integration into vehicles or for optimizing costs, size and power consumption, the display is optional. An accelerometer may also be added to provide additional functionalities: Switching the sensing unit from a very low power sleep mode to an active measuring mode; Adjusting the data sampling frequency based on moving speed, for example corresponding to sensing from a pedestrian (measurement every minute), a bicycle (sampling every 30 seconds), a bus (one data point every 10 seconds); and Recording and transmitting information pertaining to road roughness.

Modularity: Preferably, the whole measuring system consists of a main board and a mezzanine board. This makes it is easy to change the functionality of the device by just switching one mezzanine board with another, for example switching from NOx and noise level to ozone and UV or from single CO2/barometer measurement to UV, ozone, humidity.

In alternative embodiments, additional features are added when desired to address data security, reprogramming, power consumption and size.

Security: Securing data transmission is preferably addressed with encryption algorithms running on the microcontroller. Because of the resource constraints on such embedded platforms, it is preferable to use a symmetric key algorithm. Algorithms such as DES, AES or TEA are also available. Data privacy is preferably provided by adding middleware consisting of an Identification Repository (IR) and a Pseudonym Server (PS).

Unit Programming: An advantage to preferred embodiments is delivered by the use of a USB port not only to recharge the battery, but also to reprogram the unit via the bootloader of the microcontroller.

Use of an ASIC: For a further reduction in power consumption and size, several functions can be implemented on Application Specific Integrated Circuits (ASIC).

Preferred embodiments of the device have a modular design that makes it possible to reduce the number of modules to the absolute minimum to meet the requirements of a particular application. For instance, if the mobile phone being used (as an intermediary to which the mobile sensing device transmits) has a GPS module, we can leverage this module instead of having to build this functionality in the device. In this example, the device is “downsized” so that it supplies only the environmental measurement. Modularity in device configuration lowers costs, battery drain and sensor size.

Data recovery and sensor calibration is optionally performed, for example, in fixed stations located on street furniture, at public bicycle stations, on street lights, advertising boards, bus stop shelters, or at specific city locations equipped with Internet connected kiosks. Unlike for mobile units, the size of electronics and their power consumption are not constraints for the fixed stations. They can be connected to the electrical grid, which provides several advantages: more sensitive instruments can be powered; they may contain several wireless communication modules in order to simultaneously connect to a large number of sensors; a continuous scan for mobile sensors in its proximity can be performed; can be amplified to extend the communication range; and can be connected to a distant server.

Fixed stations preferably serve two functions: Data collection from the mobile sensors if these are operated in local recording mode; and Sensor recalibration. When mobile sensors come within range of the fixed station, the sequence for data recovery is the following: Detect the presence of sensor; Obtain device ID (Most likely its name or MAC address); Establish a secure communication; Send a command to List all the files on the local storage medium; Initiate transfer using file transfer protocols (for example OBEX or FTP); After transfer is completed and its integrity verified, erase file from storage medium; Transmit said file to a distant server; and Close communication with mobile sensor.

### Example

### Calibration Check Procedure

The following are exemplary steps performed in a calibration and check procedure: Detecting the presence of a mobile sensor; Obtaining its device ID (Most likely its name or MAC address); Establishing a secure communication; Sending a command to the Mobile unit to place it in measuring mode for a certain set of parameters: measuring requested parameters with the mobile sensor; measuring requested parameters with a fixed station; retrieving mobile sensor values by the fixed station; comparing the fixed station and mobile sensor values using an algorithm running on the fixed station; if the difference between the values at mobile sensors and fixed station sensors is greater than a user defined amount, the fixed station sends a new calibration file to the mobile unit (This file can consist of amplification values, offsets, or entire tables); staying in close communication with the mobile sensor; and sending measured sensor value and calibration file to the distant server.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the environmental measurement industry.

What is claimed is:

1. A method of reporting local environmental conditions in real time, the method comprising the steps of:
providing a sensor that takes measurements of an environmental condition;
attaching the sensor to an object, the object selected from the group consisting of a vehicle, a person, and a fixed-position structure; and
displaying visible light to the public at a scale visible from at least 30 feet from the visible light, said visible light controlled by a microcontroller receiving information from the sensor, said visible light being variable to depict the measurements.

2. The method of claim 1, wherein the sensor is a module that is removably added to a printed circuit board, the printed circuit board comprising the microcontroller, a physical storage medium, and an input and output transceiver; the method further comprising the steps of: storing the measurements on the physical storage medium; and transmitting the measurements to a remote receiver.

3. The method of claim 2, further comprising the step of setting the microcontroller power mode and data sampling frequency automatically using a speed measuring electronic component.

4. The method of claim 2, further comprising the step of calibrating the sensor periodically using data transmitted to the input and output transceiver from a reference station.

5. The method of claim 1, wherein the environmental condition comprises a level of a contaminant selected from the group consisting of ozone, carbon monoxide, nitrous oxide, nitrogen dioxide, sulfur dioxide, carbon dioxide, volatile organic compounds, radiation, noise, and particulates.

6. The method of claim 1, wherein the environmental condition comprises a gas concentration, the method further comprising the step of controlling air flow to the sensor using a direct current fan to provide a constant air flow through a fixed volume.

7. The method of claim 1, further comprising the steps of: measuring temperature and relative humidity values in vicinity of the sensor; and calculating correction factors for the measurements using said temperature and humidity values.

8. The method of claim 1, further comprising the steps of: correcting the measurements by compensating for resistivity spread pertaining to manufacturing or aging of the sensor; and maintaining an optimal operating temperature of the sensor while in use.
